(19) United States
(12) Patent Application Publication
(10) Pub. No.: US 2020/0242658 A1
(43) Pub. Date: Jul. 30, 2020

(54) METHOD AND APPARATUS FOR DETERMINING EFFECTIVENESS OF DIGITAL ADVERTISEMENTS

(71) Applicant: Walmart Apollo, LLC, Bentonville, AR (US)

(72) Inventors: Gurgen Tumanyan, San Francisco, CA (US); Rajesh Garigipati, Dublin, CA (US)

(21) Appl. No.: 16/256,777

(22) Filed: Jan. 24, 2019

(51) Int. Cl. G06Q 30/02

(52) U.S. Cl. CPC G06Q 30/0246; G06Q 30/0277; G06Q 30/0247

(57) ABSTRACT

This application relates to apparatus and methods for determining the effectiveness of digital advertisements in influencing purchasing decisions. A computing device obtains transaction data identifying previously purchases for at least one customer. The computing device may transmit an impression data request to a digital advertisement data server that provides impression data. In response to the request, the computing device receives impression data identifying impressions of at least one digital advertisement from multiple computing devices. The computing device can determine that the customer does not correspond to a first impression identity, but does correspond to a second impression identity based on matching a portion of the transaction data to a portion of the impression data. The computing device can then generate a record of attribute data identifying that the customer corresponds to the second impression identity.

### TECHNICAL FIELD

The disclosure relates generally to advertising and, more specifically, to determining the effectiveness of digital advertisements.

### BACKGROUND

An advertisement may be a presentation or communication to promote an item, such as a product or service, for purchase. At least some advertisements are digital advertisements, which include a digital representation of the presentation or communication, such as one displayed on a website. A sponsor of an advertisement, such as a business, may seek to sell the item in the advertisement. The sponsor may advertise the item in the advertisement to notify potential buyers of the sale of the item, thereby increasing the chances of selling the item. Some sponsors run advertisement campaigns whereby they advertise one or more products on various platforms, such as websites.

At least some of these sponsors monitor the performance of their digital advertisements, for example, to determine how effective or helpful the digital advertisement is in selling the advertised item. For example, they may subscribe to a service that provides digital advertisement impression information, such as a timestamp and network address associated with the viewing of a digital advertisement on a website. The sponsors may attempt to match sold items, such as items sold via a retailer's website, to the digital advertisement impression information. Often times, however, the sponsor is unable to accurately match a sold item. For example, the advertisement impression information may include multiple views of the same digital advertisement from various network addresses over a same time period. As a result, the sponsor may be unable to accurately match the sold item to the customer that made the purchase, and thus may not receive revenue based on the viewing of the digital advertisement. As such, there are opportunities to improve the monitoring of the performance of digital advertisements for these and other reasons as well.

### SUMMARY

The embodiments described herein are directed to automatically matching digital advertisements viewed by customers to online or in-store sales made of those items. The embodiments may solve one or more problems present in the prior art, such as those discussed above. As a result, a sponsor or retailer is more effectively able to track the effectiveness of their digital advertisements (e.g., online ads).

In some embodiments, a computing device and a database are provided. The computing device is communicatively coupled to the database and is configured to obtain, from the database, transaction data identifying a plurality of previously placed orders for at least one transaction identity. The computing device may transmit an impression data request for impression data to, for example, a digital advertisement data server. The computing device may receive, in response to the impression data request, impression data identifying a plurality of impressions of at least one digital advertisement for a plurality of impression identities. The computing device may determine that the at least one transaction identity does not correspond to a first impression identity of the plurality of impression identities. Based on determining that the at least one transaction identity does not correspond to the first impression identity, the computing device may determine that the at least one transaction identity corresponds to a second impression identity of the plurality of impression identities. The computing device may then generate an indication of the determination that the at least one transaction identity corresponds to the second impression identity.

In some embodiments, a method is provided that includes obtaining transaction data identifying a plurality of previously placed orders for at least one transaction identity. The method may also include transmitting an impression data request for impression data. The method may include receiving, in response to the impression data request, impression data identifying a plurality of impressions of at least one digital advertisement for a plurality of impression identities. The method may further include determining that the at least one transaction identity does not correspond to a first impression identity of the plurality of impression identities. The method may also include, based on determining that the at least one transaction identity does not correspond to the first impression identity, determining that the at least one transaction identity corresponds to a second impression identity of the plurality of impression identities. The method may further include generating an indication of the determination that the at least one transaction identity corresponds to the second impression identity.

In yet other embodiments, a non-transitory computer readable medium has instructions stored thereon, where the instructions, when executed by at least one processor, cause a device to perform operations that include obtaining transaction data identifying a plurality of previously placed orders for at least one transaction identity. The operations may also include transmitting an impression data request for impression data. The operations may include receiving, in response to the impression data request, impression data identifying a plurality of impressions of at least one digital advertisement for a plurality of impression identities. The operations may further include determining that the at least one transaction identity does not correspond to a first impression identity of the plurality of impression identities. The operations may also include, based on determining that the at least one transaction identity does not correspond to the first impression identity, determining that the at least one transaction identity corresponds to a second impression identity of the plurality of impression identities. The operations may further include generating an indication of the determination that the at least one transaction identity corresponds to the second impression identity.

### BRIEF DESCRIPTION OF THE DRAWINGS

The features and advantages of the present disclosures will be more fully disclosed in, or rendered obvious by the following detailed descriptions of example embodiments. The detailed descriptions of the example embodiments are to be considered together with the accompanying drawings wherein like numbers refer to like parts and further wherein:

FIG. 1 is a block diagram of a digital advertisement monitoring system in accordance with some embodiments;

FIG. 2 is a block diagram of the digital advertisement monitoring computing device of FIG. 1 in accordance with some embodiments;

FIG. 3 is a block diagram illustrating examples of various portions of the digital advertisement monitoring computing device and database of FIG. 1 in accordance with some embodiments;

FIG. 4 a diagram illustrating an example attribution record that may be generated by the digital advertisement monitoring computing device of FIG. 1 in accordance with some embodiments;

FIG. 5 is a flowchart of an example method that can be carried out by the digital advertisement monitoring computing device of FIG. 1 in accordance with some embodiments; and

FIG. 6 is a flowchart of another example method that can be carried out by the digital advertisement monitoring computing device of FIG. 1 in accordance with some embodiments.

### DETAILED DESCRIPTION

The description of the preferred embodiments is intended to be read in connection with the accompanying drawings, which are to be considered part of the entire written description of these disclosures. While the present disclosure is susceptible to various modifications and alternative forms, specific embodiments are shown by way of example in the drawings and will be described in detail herein. The objectives and advantages of the claimed subject matter will become more apparent from the following detailed description of these exemplary embodiments in connection with the accompanying drawings.

It should be understood, however, that the present disclosure is not intended to be limited to the particular forms disclosed. Rather, the present disclosure covers all modifications, equivalents, and alternatives that fall within the spirit and scope of these exemplary embodiments. The terms “couple,” “coupled,” “operatively coupled,” “operatively connected,” and the like should be broadly understood to refer to connecting devices or components together either mechanically, electrically, wired, wirelessly, or otherwise, such that the connection allows the pertinent devices or components to operate (e.g., communicate) with each other as intended by virtue of that relationship.

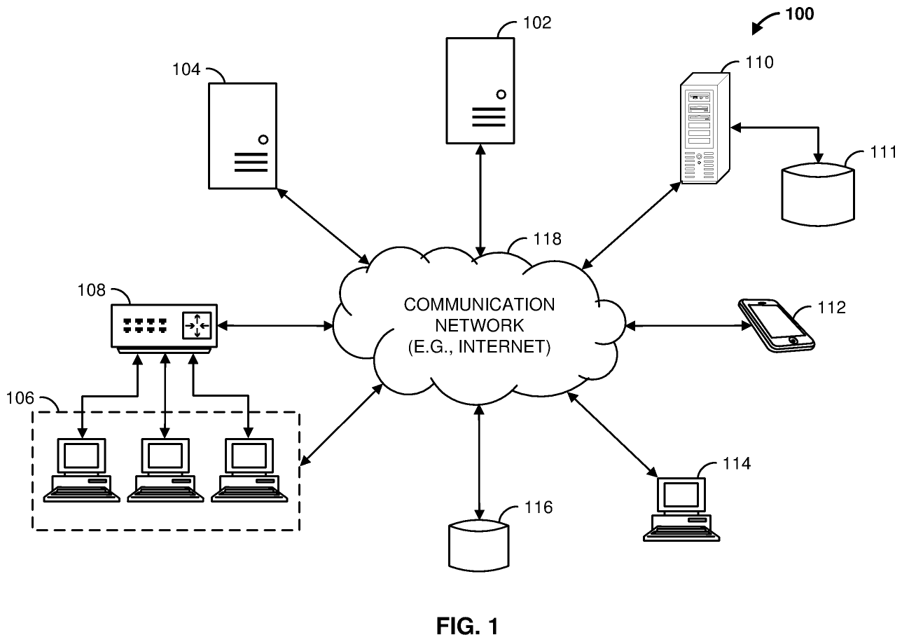

Turning to the drawings, FIG. 1 illustrates a block diagram of a digital advertisement monitoring system 100 that includes a digital advertisement monitoring computing device 102 (e.g., a server, such as an application server), a web hosting device 104 (e.g., a web server), workstation(s) 106, database 116, digital advertisement data server 110, and multiple customer computing devices 112, 114 operatively coupled over network 118. Digital advertisement monitoring computing device 102, web hosting device 104, digital advertisement data server 110, and multiple customer computing devices 112, 114 can each be any suitable computing device that includes any hardware or hardware and software combination for processing and handling information. In addition, each can transmit data to, and receive data from, communication network 118.

For example, each of digital advertisement monitoring computing device 102, web hosting device 104, digital advertisement data server 110, and multiple customer computing devices 112, 114 can be a computer, a workstation, a laptop, a mobile device such as a cellular phone, a web server, an application server, a cloud-based server, or any other suitable device. Each can include, for example, one or more processors, one or more field-programmable gate arrays (FPGAs), one or more application-specific integrated circuits (ASICs), one or more state machines, digital circuitry, or any other suitable circuitry.

Although FIG. 1 illustrates two customer computing devices 112, 114, digital advertisement monitoring system 100 can include any number of customer computing devices 112, 114. Similarly, digital advertisement monitoring system 100 can include any number of workstation(s) 106, digital advertisement monitoring computing devices 102, web servers 104, digital advertisement data servers 110, and databases 116.

Workstation(s) 106 are operably coupled to communication network 118 via router (or switch) 108. For example, workstation(s) 106 can communicate with digital advertisement monitoring computing device 102 over communication network 118. The workstation(s) 106 can allow for the configuration and/or programming of digital advertisement monitoring computing device 102, such as the controlling and/or programming of one or more processors of digital advertisement monitoring computing device 102. Workstation(s) 106 may also communicate with web server 104. For example, web server 104 may host one or more web pages, such as a retailer's website. Workstation(s) 106 may be operable to access and program (e.g., configure) the webpages hosted by web server 104.

Digital advertisement monitoring computing device 102, web server 104, and workstation(s) 106 may be operated by a retailer. Customer computing devices 112, 114 may be computing devices operated by customers of a retailer. For example, web server 104 may host one or more web pages for the retailer. Each customer computing device 112, 114 may be operable to access the one or more webpages hosted by web server 104 over communication network 118. For example, a customer operating a customer computing device 112, 114 may view a digital advertisement on a webpage hosted by web server 104, and purchase the advertised product from the retailer's website, also hosted on web server 104. In some examples, a digital advertisement is placed on a webpage hosted by another web server.

Digital advertisement monitoring computing device 102 is operable to communicate with database 116 over communication network 118. For example, digital advertisement monitoring computing device 102 can store data to, and read data from, database 116. Database 116 may be a tangible, non-transitory memory. For example, database 116 may be a remote storage device, such as a cloud-based server, a memory device on another application server, a networked computer, or any other suitable remote storage. Although shown remote to digital advertisement monitoring computing device 102, in some examples, database 116 can be a local storage device, such as a hard drive, a non-volatile memory, or a USB stick. Database 116 may store data, such as transaction data, related to a customer's purchase of an item. For example, database 116 may store transaction data for items bought in a store, and may store transaction data for items bought online, such as on a retailer's website.

Digital advertisement data server 110 may be operated by a third party, and may provide impression data, such as an online identification (ID), a network address, and timestamp, for example. The online ID may be a unique identifier (e.g., set of alphanumeric characters, number) stored on the computing device used to view the digital advertisement. The timestamp may include a date and time of when the digital advertisement was viewed, and the network address may be the network address of the computing device used to view the digital advertisement when the digital advertisement was viewed. In some examples, impression data may include one or more of a creative ID (e.g., the image shown in an advertisement), an advertisement size (e.g., the size of the advertisement, pixel count), a campaign advertisement ID. In some examples, the impression data may include information about the device on which the advertisement was shown, such as an operating system (OS), browser, IP address, or any other related information. Impression data may also identify the a cookie stored by the browser.

Digital advertisement data server 110 may determine the impression data based on one or more cookies stored on the computing devices accessing the webpage hosting the digital advertisement. For example, a customer, operating a customer computing device 112, 114, may view a digital advertisement on a webpage hosted by web server 104. Web server 104 may determine impression data for the view of the digital advertisement by accessing a cookie stored on the computing device accessing the webpage hosting the digital advertisement. The cookie may identify the online ID, the timestamp of when the digital advertisement was viewed, and the network address of the customer computing device used to view the digital advertisement. Web server 104 may transmit a message identifying the impression data to digital advertisement data server 110, and digital advertisement data server 110 may store the impression data in a non-transitory memory, such as database 111. Digital advertisement data server 110 may obtain impression data for multiple views of multiple digital advertisements on multiple webpages, for example.

Digital advertisement monitoring computing device 102 may be operable to request and receive the impression data from digital advertisement data server 110 over communication network 118. In response, digital advertisement data server 110 may provide impression data related to one or more advertisement campaigns that belong to a retailer. For example, digital advertisement data server 110 may provide a continuous feed of all impression data records that belong to any campaigns run by the retailer.

Communication network 118 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. Communication network 118 can provide access to, for example, the Internet.

Digital advertisement monitoring system 100 may allow for the determination of a digital advertisement's effectiveness, such as a digital advertisement placed on a webpage, by matching impressions (e.g., views) of the digital advertisement on the webpage to either in-store or online purchases. For example, and as described in further detail below, digital advertisement monitoring computing device 102 may obtain transaction data for a particular transaction from database 116. The transaction data may include, for example, a list of items purchased in the particular transaction. The transaction data may also include a customer identification (ID) for the purchase, which may identify the purchasing customer.

Based on the obtained transaction data, digital advertisement monitoring computing device 102 may request impression data from digital advertisement data server 110 over a particular time period. For example, digital advertisement monitoring computing device 102 may request and receive from digital advertisement data server 110 impression data for a digital advertisement advertising an item in the list of purchased items identified in the transaction data obtained from database 116 for views over a time period (e.g., the last 7 days, 14 days, or 28 days). The impression data may identify, for example, multiple views, by multiple computing devices, of the digital advertisement over the requested time period.

Digital advertisement monitoring computing device 102 may determine whether a customer ID associated with a particular purchased item, as identified in the obtained transaction data, maps to an online ID identified by the impression data. For example, digital advertising monitoring computing device 102 may associate a locally unique identifier (LUID) with each online ID identified by impression data. Digital advertising monitoring computing device 102 may also associate an LUID with each customer ID associated with purchases. Digital advertising monitoring computing device 102 may determine whether an LUID associated with a customer ID for a particular purchase (e.g., as identified by transaction data) matches an LUID associated with any online ID identified in obtained impression data.

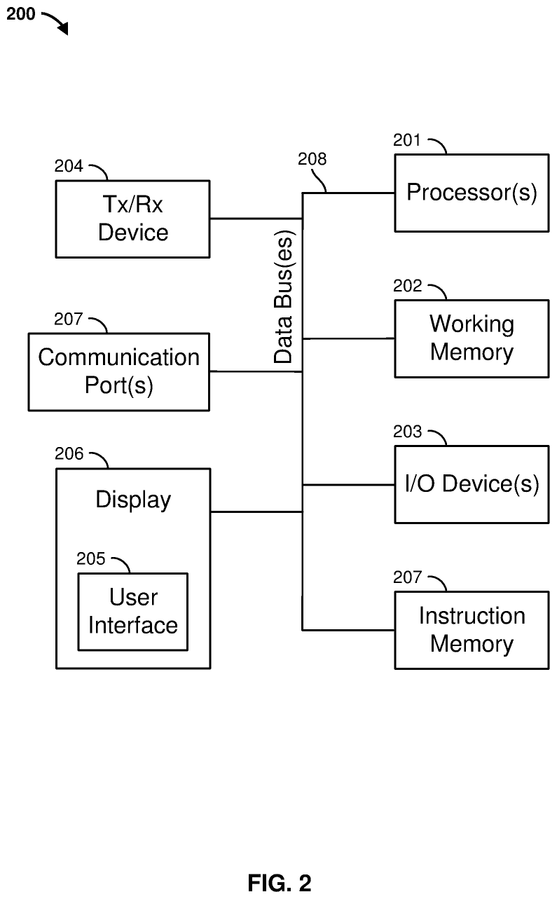

FIG. 2 illustrates the digital advertisement monitoring computing device 102 of FIG. 1. Digital advertisement monitoring computing device 102 can include one or more processors 201, working memory 202, one or more input/output devices 203, instruction memory 207, a transceiver 204, one or more communication ports 207, and a display 206, all operatively coupled to one or more data buses 208. Data buses 208 allow for communication among the various devices. Data buses 208 can include wired, or wireless, communication channels.

Processors 201 can include one or more distinct processors, each having one or more cores. Each of the distinct processors can have the same or different structure. Processors 201 can include one or more central processing units (CPUs), one or more graphics processing units (GPUs), application specific integrated circuits (ASICs), digital signal processors (DSPs), and the like.

Processors 201 can be configured to perform a certain function or operation by executing code, stored on instruction memory 207, embodying the function or operation. For example, processors 201 can be configured to perform one or more of any function, method, or operation disclosed herein.

Instruction memory 207 can store instructions that can be accessed (e.g., read) and executed by processors 201. For example, instruction memory 207 can be a non-transitory, computer-readable storage medium such as a read-only memory (ROM), an electrically erasable programmable read-only memory (EEPROM), flash memory, a removable disk, CD-ROM, any non-volatile memory, or any other suitable memory.

Processors 201 can store data to, and read data from, working memory 202. For example, processors 201 can store a working set of instructions to working memory 202, such as instructions loaded from instruction memory 207. Processors 201 can also use working memory 202 to store dynamic data created during the operation of digital advertisement monitoring computing device 102. Working memory 202 can be a random access memory (RAM) such as a static random access memory (SRAM) or dynamic random access memory (DRAM), or any other suitable memory.

Input-output devices 203 can include any suitable device that allows for data input or output. For example, input-output devices 203 can include one or more of a keyboard, a touchpad, a mouse, a stylus, a touchscreen, a physical button, a speaker, a microphone, or any other suitable input or output device.

Communication port(s) 207 can include, for example, a serial port such as a universal asynchronous receiver/transmitter (UART) connection, a Universal Serial Bus (USB) connection, or any other suitable communication port or connection. In some examples, communication port(s) 207 allows for the programming of executable instructions in instruction memory 207. In some examples, communication port(s) 207 allow for the transfer (e.g., uploading or downloading) of data, such as data related to a customer's previous order history.

Display 206 can display user interface 205. User interfaces 205 can enable user interaction with digital advertisement monitoring computing device 102. For example, user interface 205 can be a user interface for an application that allows for the viewing of semantic representations of user queries. In some examples, a user can interact with user interface 205 by engaging input-output devices 203. In some examples, display 206 can be a touchscreen, where user interface 205 is displayed on the touchscreen.

Transceiver 204 allows for communication with a network, such as the communication network 118 of FIG. 1. For example, if communication network 118 of FIG. 1 is a cellular network, transceiver 204 is configured to allow communications with the cellular network. In some examples, transceiver 204 is selected based on the type of communication network 118 digital advertisement monitoring computing device 102 will be operating in. Processor(s) 201 is operable to receive data from, or send data to, a network, such as communication network 118 of FIG. 1, via transceiver 204.

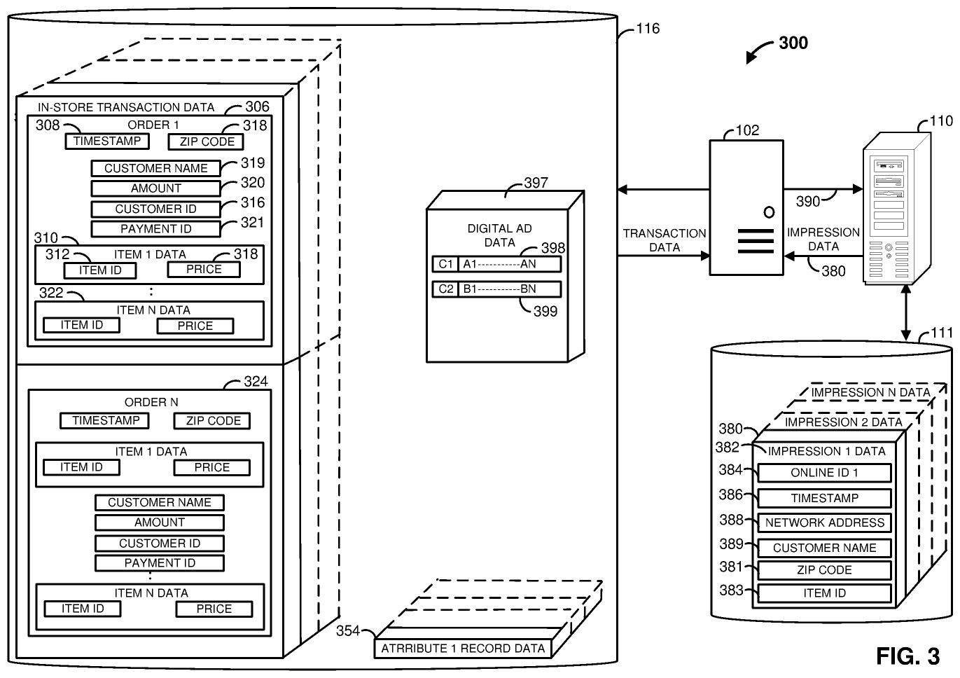

FIG. 3 is a block diagram illustrating examples of various portions of the digital advertisement monitoring computing device 102 and database 116 of FIG. 1. As indicated in the figure, database 116 includes customer transaction data 302, which identifies previous transactions, such as purchase orders, for one or more customers. The transactions may have taken place in-store, or online. For example, in-store transaction data 306 identifies and characterizes an in-store transaction, and online transaction data 324 identifies and characterizes an online transaction. Customer transaction data 302 may be generated by, for example, a computing device. For example, at a retailer's location, a computing device, such as workstation 106, may generate in-store transaction data 306 for a completed transaction (e.g., purchase), and may store the in-store transaction data 306 in database 116. For online purchases, a web server, such as web server 104, may generate online transaction data 324, and may store the online transaction data 324 in database 116.

Database 116 may store transaction data 302, such as in-store transaction data 306 and online transaction data 324, for multiple transactions involving multiple customers. In-store transaction data 306 may include, for example, data identifying and characterizing one or more previous in-store purchases. For example, the data may include a transaction timestamp 308 identifying a date and/or time of the transaction, and an amount 320 (e.g., purchase cost) of the transaction. The data may also include a customer ID 316, which may be a household ID that identifies a household (e.g., people living together at a particular address). The data may also include a transaction zip code 318, which may identify the zip code of an address of the customer, or the zip code of the retailer's location where the transaction is being made. In some examples, the data may include a customer name 319 identifying the name of the customer. In some examples, the data may include a payment identifier 321, identifying the payment form, such as a credit card number used for the in-store transaction. The data may also include item data 310, 322 identifying one or more items that were purchased. For example, each item data 310, 322 may identify an item identification (ID) 312 of a purchased item, which may be a stock keeping unit (SKU) of the item in some examples. Item data 310, 322 may also include a price 318 of the purchased item.

Online transaction data 324 may include, for example, data identifying and characterizing one or more previous online purchases. For example, the data may include a transaction timestamp 328 identifying a date and/or time of the online transaction, and a purchase amount 340 of the transaction. The data may also include a customer ID 336, which may identify the customer's online account, for example. The data may also include a purchase zip code 358, which may identify the zip code of an address of the customer. In some examples, the data may include a customer name 359 identifying the name of the customer, and a payment identifier 351, identifying the payment form, such as a credit card number used for the online transaction. The data may also include item data 350, 372 identifying one or more items that were purchased. For example, each item data 350, 372 may identify an item identification (ID) 352 of a purchased item, which may be an SKU of the item in some examples. Item data 350, 372 may also include a price 358 of the purchased item.

Database 116 may also store digital advertisement data 397 identifying one or more digital advertisements. For example, digital advertisement data 397 may identify digital advertisements displayed on one or more webpages, such as on a webpage for a website hosted by web server 104. The digital advertisements may promote an item, such as one sold by a retailer operating digital advertisement monitoring computing device 102. The digital advertisements may allow a customer to engage (e.g., click on) the digital advertisement to proceed to a product page of the advertised item, that may allow for the purchase of the advertised item. Digital advertisement data 397 may identify one or more advertising campaigns 398, 399. Each advertising campaign 398, 399 may identify one or more digital advertisements, as indicated in the figure (e.g., advertising campaign “C1” is associated with digital advertisements “A1” through “AN,” and advertising campaign “C2” is associated with digital advertisements “B1” through “BN”). Digital advertisement data 397 may be stored in database 116 by, for example, workstations 106 or digital advertisement monitoring computing device 102.

Digital advertisement monitoring computing device 102 may be operable to obtain transaction data 302 from database 116. For example, digital advertisement monitoring computing device 102 may obtain, from database 116, in-store transaction data 306 identifying in-store transactions, and online transaction data 324 identifying online transactions.

Digital advertisement monitoring computing device 102 may also be operable to obtain impression data 380 from digital advertisement data server 110. For example, digital advertisement monitoring computing device 102 may transmit an impression data request 390 to digital advertisement data server 110 over communication network 118. The impression data request 390 may identify (e.g., specify) any of transaction data 302. If requesting impression data based on in-store transactions, the impression data request 390 may identify one or more items of in-store transaction data 306. For example, impression data request 390 may identify one or more of a customer name 319, a payment identifier 321, a customer ID 316, a purchase zip code 318, or item data 310, 322. If requesting impression data based on online transactions, the impression data request 390 may identify one or more items of online transaction data 324. For example, impression data request 390 may identify one or more of a customer name 359, a payment identifier 351, a customer ID 336, a purchase zip code 358, or item data 350, 372.

Based on impression data request 390, digital advertisement data server 110 may determine one or more impressions of digital advertisements. For example, digital advertisement data server 110 may determine a plurality of impressions from multiple computing devices for a digital advertisement, where the determined plurality of impressions and/or the digital advertisement satisfy the specifications identified in impression data request 390. For example, if impression data request 390 requests impression information for a particular customer name (e.g., customer name 319, customer name 359), digital advertisement data server 110 may provide impression information for all impressions that identify the same customer name. In some examples, the digital advertisement data server 110 provides impression information for all advertisement campaigns belonging to a retailer. For example, in response to an impression data request 390, digital advertisement data server 110 may continuously provide the impression information (e.g., in a feed, as it becomes available).

Database 111 may store impression data 380, which identifies impression information for a plurality of digital advertisements. For example, first impression data 382 may identify impression data for a particular digital advertisement, such as one identified by digital advertisement data 397 stored in database 116. The impression data may include, for example, an online ID 384, a timestamp 386 of when the digital advertisement was viewed, a network address 388 of the computing device used to view the digital advertisement, a customer name 389, a zip code 381, or an item ID 383, such as an SKU of the advertised item. In some examples, digital advertisement data server 110 searches database 111 for impression information that satisfies the specifications identified in impression data request 390. Digital advertisement data server 110 may then obtain the impression information satisfying the specifications from database 111.

In some examples, impression data request 390 identifies a period of time. In response, digital advertisement data server 110 may provide impression information only for impressions of digital advertisements over that period of time. For example, impression data request 390 may identify a period of time of 7 days, 14 days, or 28 days. Digital advertisement data server 110 may provide impression information only for impressions that took place over the last 7 days, 14 days, or 28 days, respectively. Digital advertisement data server 110 may determine whether impressions took place over the period of time based on timestamp 386, for example.

Digital advertisement monitoring computing device 102 may receive impression data 380 in response to impression data request 390. Impression data 380 may identify impression data for a plurality of identities (e.g., customers). For example, impression data 380 may identify impression data for multiple views from different network addresses of the same digital advertisement. As another example, impression data 380 may identify impression data for multiple views from of the same digital advertisement associated with customers with the same name (e.g., as identified by customer name 389 for each of the impressions). While all impressions may be associated with a same customer name 389, the received impression data 380 may indicate that each view is associated with a different network address 388, or different zip code 381. As yet another example, impression data 380 may identify impression data for multiple views from of the same digital advertisement associated with impressions from the same zip code (e.g., as identified by zip code 381 for each of the impressions). While all impressions may be associated with a same zip code 381, the received impression data 380 may indicate that each view is associated with a different network address 388, or different customer name 389.

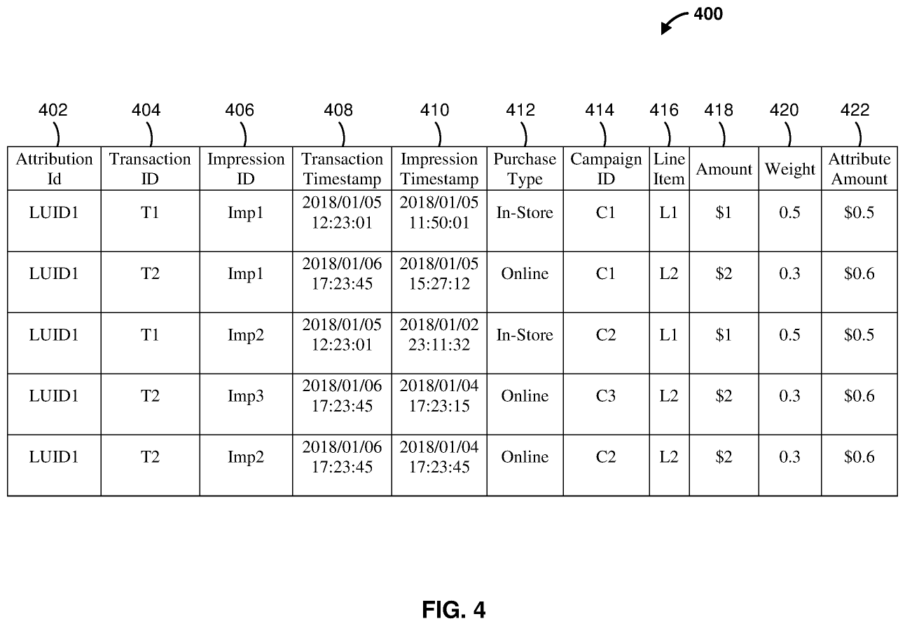

Digital advertisement monitoring computing device 102 is operable to determine whether impression data 380 received for any identity matches an identity for one or more transactions as identified by transaction data 302. For example, digital advertisement monitoring computing device 102 may determine whether a customer name for a first identity identified by impression data 380 (e.g., as identified by customer name 389) matches a customer name for a transaction (e.g., such as customer name 319 identified by in-store transaction data 306, or customer name 359 identified by online transaction data 324). If there is a match, in some examples, digital advertisement monitoring computing device 102 will store data related to the match as a record of attribution data 354 in database 116. An example of a record of attribution data 354 is discussed in more detail with respect to FIG. 4. If there is no match, in some examples, digital advertisement monitoring computing device 102 will determine whether a customer name for a second identity identified by impression data 380 matches the customer name for the transaction. In some examples, digital advertisement monitoring computing device 102 determines whether any identities as identified by impression data 380 match the customer name for the particular transaction.

In some examples, regardless of whether there is a match, digital advertisement monitoring computing device 102 determines whether the customer name for the first identity identified by impression data 380 matches any other customer names for other transactions as identified by transaction data 302. If there are no other matches, digital advertisement monitoring computing device 102 will store data related to the match as a record of attribution data 354 in database 116. If there are other matches, digital advertisement monitoring computing device 102 will randomly select a match and store data related to the match as a record of attribution data 354 in database 116.

Although a match of customer names was described above, digital advertisement monitoring computing device 102 may use any data identified by impression data 380 for any number of entities to determine if the data matches to any data identified by transaction data 302 for a particular transaction. In some examples, digital advertisement monitoring computing device 102 determines whether impression data 380 received for any identity matches an identity for one or more transactions as identified by transaction data 302 based on a match of zip codes (e.g., zip code 381 to purchase zip code 318, 358). In some examples, digital advertisement monitoring computing device 102 determines the zip code of the computing device used to view the digital advertisement based on a network address 388 received in impression data 380. In some examples, digital advertisement monitoring computing device 102 determines whether impression data 380 received for any identity matches an identity for one or more transactions as identified by transaction data 302 based on a match, or the closeness of, timestamps (e.g., which of transaction timestamps 328, or transaction timestamps 308, is closest to timestamp 386).

In some examples, digital advertisement monitoring computing device 102 determines whether impression data 380 received for any identity matches an identity for one or more transactions as identified by transaction data 302 based on a match of item IDs (e.g., item ID 383 matches item ID 312 or item ID 352). As such, an impression may be matched not only to an in-store or online transaction, but to a particular item purchased in the transaction. In yet other examples, digital advertisement monitoring computing device 102 determines whether impression data 380 received for any identity matches an identity for one or more transactions as identified by transaction data 302 based on any other data identified by transaction data 302 and impression data 380.

FIG. 4 illustrates a diagram illustrating an example attribution record 400 that identifies a particular impression identity and transaction identify match, and may be generated by the digital advertisement monitoring computing device 102 of FIG. 1. For example, digital advertisement monitoring computing device 102 may generate, or add to, an attribute record 400 when digital advertisement monitoring computing device 102 matches an impression identity identified by impression data 380 to a transaction identity identified by transaction data 302

As illustrated in the diagram, attribution record 400 includes an attribution ID column 402, a transaction ID column 404, an impression ID column 406, a transaction timestamp column 408, an impression timestamp column 410, a purchase type column 412, a campaign ID column 414, a line item column 416, and amount column 418, a weight column 420, and an attribute amount column 422, for a plurality of attribution data sets (e.g., 5 in this example). Although these various columns are illustrated, attribution record 400 is only an example. Other attribution record examples may include a partial set of the illustrated columns or additional columns, for example. In addition, while some attribution data sets may have data associated with each column, other attribution data sets may have data associated with only one or some of the columns. Additionally, the structure of the attribution record 400 is only exemplary, and those skilled in the art having the benefit of these disclosures would appreciate other attribute record structures as well.

Attribution ID column 402 identifies an identifier, such as an LUID, associated with the matching of corresponding impression and transaction identities. The identifier may be, for example, a matched customer ID (e.g., customer ID 306 matched to online ID 384), or a unique identifier, assigned to the attribute data set. In this example, all attribute data sets are associated with attribution ID “LUID1.” As such, all are associated with a same customer. Transaction ID column 404 identifies the transaction (e.g., as identified in-store transaction data 306, online transaction data 324) associated with the attribute data set. In this example, the first and third attribute data sets are associated with the same transaction “T1,” and the second, fourth, and fifth attribute data sets are associated with the same transaction “T2.”

Impression ID column 406 identifies the impression (e.g., as identified by first impression data 382) associated with the corresponding attribute data set. In this example, the first two attribute data sets are associated with the same impression “Imp1,” the second and fifth attribute data sets are associated with the same impression “Imp2,” and the fourth attribute data set is associated with a third impression “Imp3.” Transaction timestamp column 408 identifies the timestamp associated with the transaction identified in the transaction ID column 404 (e.g., transaction timestamp 308).

Impression timestamp column 410 identifies the timestamp associated with the impression identified in the impression ID column 406 (e.g., transaction timestamp 386). Purchase type column 412 identifies whether the transaction was in-store or online. Campaign ID column 414 identifies the digital advertisement campaign, if any, for the digital advertisement associated with the impression identified in the impression ID column 406 (e.g., advertising campaign 398, 399). Line item column 416 identifies the item ID, such as an SKU, of an item corresponding to the transaction identified in the transaction ID column 404 (e.g., item ID 312, or item ID 383).

The amount column 418 identifies a purchase amount for the item identified in the line item column 416. The weight column 420 identifies an attribution weight that is to be given to the corresponding digital advertisement for the purchased item. For example, digital advertisement monitoring computing device 102 may determine that a transaction matches to impressions of multiple digital advertisements. In some examples, digital advertisement monitoring computing device 102 equally divides the attribution among the impressions for the purchase. For example, if there were two matches, then each digital advertisement would receive 50% attribution. If there were ten matches, then each digital advertisement would receive 10% attribution.

In this example, the transaction identified as “T1” in the first and third attribute data records correspond with the purchase of an item at line item “L1,” as identified in line item column 416, for an amount of $1 as identified in the amount column 418. Because, in this example, two impressions were viewed (e.g., “Imp1” for first attribute data set, and “Imp2” for the third attribute data set), a weight of 0.5 (e.g., 50%) was given to each associated digital advertisement. Similarly, the transaction identified as “T2” in the second, fourth, and fifth attribute data records correspond with an amount of $2. Because three impressions were viewed, a weight of 0.33 (e.g., 33.3%) was given to each associated digital advertisement.

In other examples, a higher weight is given to a digital advertisement that was viewed more recently (e.g., as determined by the impression timestamp identified in the impression timestamp column 410). In yet other examples, the weight is based on how long ago the impression was viewed (e.g., different weights based on the time period (e.g., 25%, split evenly, for impressions viewed earlier than 50% of a requested time period, and 75%, split evenly, for impressions viewed later than 50% of the requested time period)).

The attribute amount column 422 identifies the portion of the amount (e.g., as identified in the amount column 418) that each digital advertisement for the impression receives. For example, the amount is multiplied by the corresponding weight to determine the attribute amount.

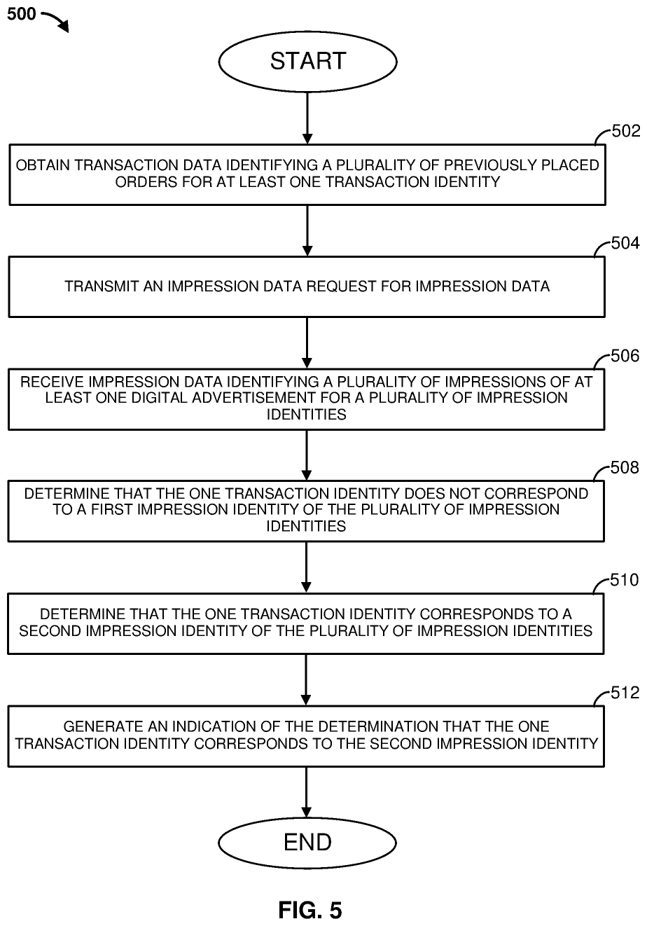

FIG. 5 is a flowchart of an example method 500 that can be carried out by the digital advertisement monitoring computing device 102 of FIG. 1. Beginning at step 502, transaction data identifying a plurality of previously placed orders for at least one transaction identity is obtained. For example, digital advertisement monitoring computing device 102 may obtain the transaction data from database 116. At step 504, an impression data request for impression data is transmitted. The impression data request 390 may be transmitted to digital advertisement data server 110, for example. At step 506, in response to the impression data request, impression data is received. The impression data identifies a plurality of impressions of at least one digital advertisement for a plurality of impression identities. For example, digital advertisement data server 110 may search database 111 for the responsive impression data, and transmit it to digital advertisement monitoring computing device 102.

Proceeding to step 508, a determination is made that the at least one transaction identity does not correspond to a first impression identity of the plurality of impression identities. For example, digital advertisement monitoring computing device 102 may determine a portion of the transaction data corresponding to the transaction identity does not match the portion of the received impression data associated with the first impression identity. Digital advertisement monitoring computing device 102 may then determine that the transaction identity does not correspond to a first impression identity.

At step 510, based on the determination that the at least one transaction identity does not correspond to the first impression identity, a determination is made that the at least one transaction identity corresponds to a second impression identity of the plurality of impression identities. For example, digital advertisement monitoring computing device 102 may determine that the portion of the transaction data corresponding to the transaction identity does match the portion of the received impression data associated with the second impression identity. Digital advertisement monitoring computing device 102 may then determine that the transaction identity does correspond to the second impression identity.

At step 512, an indication of the determination that the at least one transaction identity corresponds to the second impression identity is generated. For example, digital advertisement monitoring computing device 102 may generate an attribute data record and store it in database 116. The method then ends.

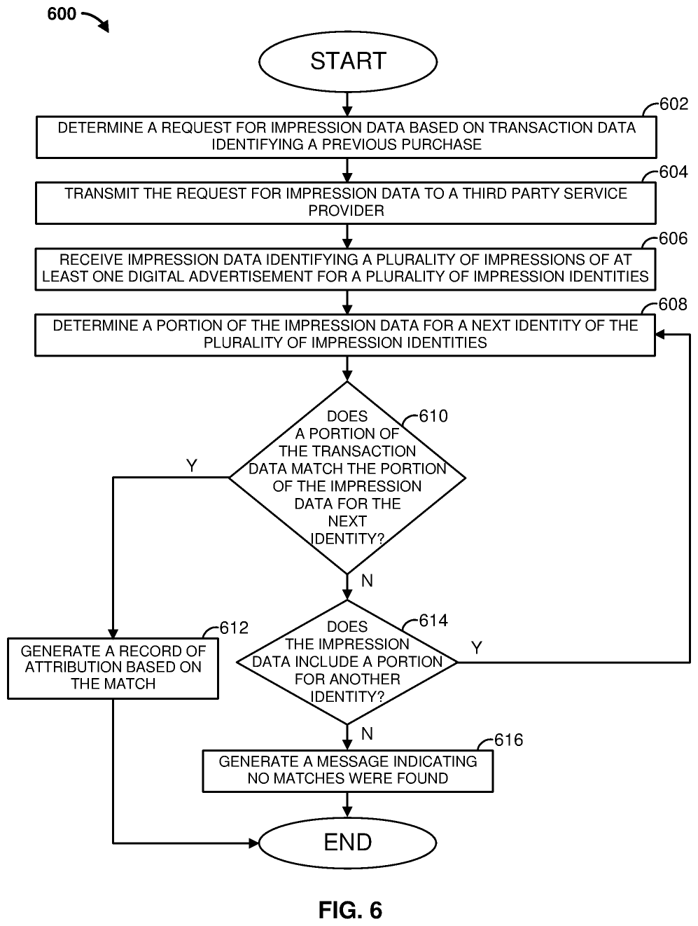

FIG. 6 is a flowchart of another example method 600 that can be carried out by the digital advertisement monitoring computing device 102 of FIG. 1. At step 602, a request for impression data is determined based on transaction data identifying a previous purchase. For example, digital advertisement monitoring computing device 102 may determine to request impression data based on a customer name, such as customer name 319, as identified by transaction data 302. At step 604, the request for impression data is transmitted to a third party service provider, such as digital advertisement data server 110. Proceeding to step 606, the requested impression data is received. The impression data may identify a plurality of impressions of at least one digital advertisement for a plurality of impression identities.

At step 608, a portion of the impression data corresponding to an impression identity of the plurality of impression identities is determined. For example, the received impression data may include portions for impressions viewed from multiple computing devices, such as customer computing devices 112, 114. Digital advertisement monitoring computing device 102 may determine a portion of the impression data corresponding to one of the multiple computing devices (e.g., one that has not been compared yet).

Proceeding to step 610, a determination is made as to whether a portion of the transaction data match the portion of the impression data for the next impression identity selected in step 608. For example, digital advertisement monitoring computing device 102 may determine whether one or more of a customer name, zip code, or customer ID identified by the portion of transaction data matches, or corresponds to, a customer name, zip code, or online ID match of the portion of impression data for the next impression identity. If a match is determined, the method proceeds to step 612, where a record of attribution is generated based on the search. Otherwise, the method proceeds to step 614.

At step 614, a determination is made as to whether the impression data includes a portion corresponding to another impression identity of the plurality of impression identities. If there is no portion of the impression data that corresponds to another identity (e.g., impression data for all impression identities has been examined), the method proceeds to step 616, where a message is generated indicating that no matches were found. For example, digital advertisement monitoring computing device 102 may generate the error message, and store it in database 116. The method then ends. Otherwise, if there is a portion of the impression data that corresponds to another impression identity, the method proceeds back to step 608 to examine that portion of the impression data for the other impression identity.

Although the methods described above are with reference to the illustrated flowcharts, it will be appreciated that many other ways of performing the acts associated with the methods can be used. For example, the order of some operations may be changed, and some of the operations described may be optional.

In addition, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

The foregoing is provided for purposes of illustrating, explaining, and describing embodiments of these disclosures. Modifications and adaptations to these embodiments will be apparent to those skilled in the art and may be made without departing from the scope or spirit of these disclosures.

What is claimed is:

1. A system comprising:
a computing device configured to:
obtain transaction data identifying a plurality of previously placed orders for at least one transaction identity;
transmit an impression data request for impression data;
receive, in response to the impression data request, impression data identifying a plurality of impressions of at least one digital advertisement for a plurality of impression identities;
determine that the at least one transaction identity does not correspond to a first impression identity of the plurality of impression identities;
based on determining that the at least one transaction identity does not correspond to the first impression identity, determine that the at least one transaction identity corresponds to a second impression identity of the plurality of impression identities; and
generate an indication of the determination that the at least one transaction identity corresponds to the second impression identity.

2. The system of claim 1, wherein the computing device is configured to:
determine that the portion of the transaction data matches with a second portion of the impression data; and
determine that the at least one transaction identity corresponds to the second impression identity of the plurality of impression identities based on the determination.

3. The system of claim 2, wherein determining that the portion of the transaction data matches with the second portion of the impression data comprises determining that an item of a transaction matches to an item advertised by the at least one digital advertisement.

4. The system of claim 2, wherein the computing device is configured to determine that the portion of the transaction data matches with the second portion of the impression data based on matching at least one of: a matching customer name, a customer identification, an online identification, a zip code, and a timestamp.

5. The system of claim 1, wherein the computing device is configured to:
determine that at least a portion of the transaction data does not match with a first portion of the impression data; and
determine that the at least one transaction identity does not correspond to the first impression identity of the plurality of impression identities based on the determination.

6. The system of claim 1, wherein the impression data request comprises a period of time, and wherein the plurality of impressions of the at least one digital advertisement were viewed within the period of time.

7. The system of claim 1, wherein the computing device is configured to generate a record of attribution based on determining that the at least one transaction identity matches to the second impression identity of the plurality of impression identities.

8. The system of claim 1, wherein the computing device is configured to:
determine that an item of the plurality of previously placed orders for the at least one transaction identity corresponds to a number of impression identities of the plurality of impression identities;
determine an attribution weight for the item based on the number of impression identities; and
determine an attribution amount for each of the number of impression identities based at least on the attribution weight.

9. The system of claim 8 wherein the computing device is configured to determine the attribute amount for each of the number of impression identities based on a transaction amount for the item.

10. A method comprising:
obtaining transaction data identifying a plurality of previously placed orders for at least one transaction identity;
transmitting an impression data request for impression data;
receiving, in response to the impression data request, impression data identifying a plurality of impressions of at least one digital advertisement for a plurality of impression identities;
determining that the at least one transaction identity does not correspond to a first impression identity of the plurality of impression identities;
based on determining that the at least one transaction identity does not correspond to the first impression identity, determining that the at least one transaction identity corresponds to a second impression identity of the plurality of impression identities; and
generating an indication of the determination that the at least one transaction identity corresponds to the second impression identity.

11. The method of claim 10 further comprising:
determining that the portion of the transaction data matches with a second portion of the impression data; and
determining that the at least one transaction identity corresponds to the second impression identity of the plurality of impression identities based on the determination.

12. The method of claim 11 wherein determining that the portion of the transaction data matches with the second portion of the impression data further comprises determining that an item of a transaction matches to an item advertised by the at least one digital advertisement.

13. The method of claim 10 further comprising:
determining that at least a portion of the transaction data does not match with a first portion of the impression data; and
determining that the at least one transaction identity does not correspond to the first impression identity of the plurality of impression identities based on the determination.

14. The method of claim 10 wherein the impression data request comprises a period of time, and wherein the plurality of impressions of the at least one digital advertisement were viewed within the period of time.

15. The method of claim 10 further comprising generating a record of attribution based on determining that the at least one transaction identity matches to the second impression identity of the plurality of impression identities.

16. The method of claim 14 further comprising:
determining that an item of the plurality of previously placed orders for the at least one transaction identity corresponds to a number of impression identities of the plurality of impression identities;
determining an attribution weight for the item based on the number of impression identities; and
determining an attribution amount for each of the number of impression identities based at least on the attribution weight.

17. A non-transitory computer readable medium having instructions stored thereon, wherein the instructions, when executed by at least one processor, cause a device to perform operations comprising:
obtaining transaction data identifying a plurality of previously placed orders for at least one transaction identity;
transmitting an impression data request for impression data;
receiving, in response to the impression data request, impression data identifying a plurality of impressions of at least one digital advertisement for a plurality of impression identities;
determining that the at least one transaction identity does not correspond to a first impression identity of the plurality of impression identities;
based on determining that the at least one transaction identity does not correspond to the first impression identity, determining that the at least one transaction identity corresponds to a second impression identity of the plurality of impression identities; and
generating an indication of the determination that the at least one transaction identity corresponds to the second impression identity.

18. The non-transitory computer readable medium of claim 16 further comprising instructions stored thereon that, when executed by at least one processor, further cause the device to perform operations comprising:
determining that the portion of the transaction data matches with a second portion of the impression data; and
determining that the at least one transaction identity corresponds to the second impression identity of the plurality of impression identities based on the determination.

19. The non-transitory computer readable medium of claim 17 further comprising instructions stored thereon that, when executed by at least one processor, further cause the device to perform operations comprising:
determining that an item of a transaction identified in the transaction data matches to an item advertised by the at least one digital advertisement identified in the impression data.

20. The non-transitory computer readable medium of claim 16 further comprising instructions stored thereon that, when executed by at least one processor, further cause the device to perform operations comprising:
determining that at least a portion of the transaction data does not match with a first portion of the impression data; and
determining that the at least one transaction identity does not correspond to the first impression identity of the plurality of impression identities based on the determination.
